(19) United States
(12) Patent Application Publication
(10) Pub. No.: US 2012/0174093 A1
(43) Pub. Date: Jul. 5, 2012

(54) SYSTEMS AND METHOD FOR DYNAMICALLY LOADING SOFTWARE PLATFORMS ONTO PLAYBACK DEVICES

(75) Inventors: Ramon Davila, San Diego, CA (US); William Wagner, Chester Springs, PA (US)

(73) Assignee: DIVX, LLC, Santa Clara, CA (US)

(21) Appl. No.: 13/332,762

(22) Filed: Dec. 21, 2011

Related U.S. Application Data
(60) Provisional application No. 61/430,135, filed on Jan. 5, 2011.

(51) Int. Cl. G06F 9/445

(52) U.S. Cl. 717/178; 717/176

(57) ABSTRACT

Systems and methods are disclosed that dynamically load a software platform for a playback device. One embodiment includes a playback device, including a processor, and memory containing a platform installer, where the platform installer configures the processor to dynamically load a software platform from a remote server into device memory that provides a runtime environment for applications using a software platform configuration.

### CROSS-REFERENCE TO RELATED APPLICATIONS

The current application claims priority to U.S. Provisional Patent Application No. 61/430,135, filed Jan. 5, 2011, the disclosure of which is incorporated herein by reference in its entirety.

### FIELD OF THE INVENTION

The present invention generally relates to consumer electronics devices and more specifically to software platforms that can be utilized to support applications on a playback device.

### BACKGROUND

The Internet connectivity of many consumer electronics (CE) devices such as televisions, DVD/Blu-ray players, mobile phones, game consoles and set-top boxes has created demand for applications such as streaming video players to be included on the devices. Consumer electronics devices are generally resource limited devices, having limited memory and processing power, in contrast with devices that are endowed with resources sufficient for a range of resource intensive functions, such as a personal computer. The development of applications for CE devices can be extremely time consuming as an Original Equipment Manufacturer (OEM) may be required to port the application for every different type or model of device that the manufacturer produces.

Providing updates to Internet connected consumer electronics devices can also be problematic. The comparative lack of security features within the processors of such devices, compared to more sophisticated devices such as personal computers, has prompted consumer electronics manufacturers to place heavy restrictions on the types of updates that can be performed due to significant security concerns with respect to valuable encryption keys that are often stored within the devices. Typically, OEMs of consumer electronics devices coordinate all software updates on the devices. Therefore, any application update is typically provided via the OEM manufacturer of the device and involves overwriting the non-volatile memory of the device.

Issues with porting applications to new consumer electronics devices and with updating applications on existing consumer electronics devices can often result in application developers maintaining many different versions of an application and having little ability to push global updates.

### SUMMARY OF THE INVENTION

Systems and methods are disclosed that dynamically load a software platform for a playback device. One embodiment includes a playback device, including a processor and memory containing a platform installer, where the platform installer configures the processor to dynamically load a software platform from a remote server into device memory that provides a runtime environment for applications using a software platform configuration.

In a further embodiment, the platform installer is configured to download the software platform configuration, where the software platform configuration specifies a set of software components that combine to form a software platform when downloaded to the playback device.

In another embodiment, where the software platform configuration is specific to the playback device.

In a still further embodiment, the software platform configuration is specific to a class of playback device.

A still another embodiment includes a host application that initializes the platform installer, where the platform installer further includes a platform assembly module and a boot loader, the boot loader is configured to manage communication between the installer and the host application, and the platform installer utilizes the platform assembly module to download the software platform configuration and to dynamically download the software platform using the software platform configuration.

In a yet further embodiment, the dynamically loaded software platform includes at least one virtual machine, a common application container and a platform runtime.

In yet another embodiment, the dynamically loaded software platform configures the processor to download at least one application.

In a further embodiment again, the at least one application is packaged as an application bundle and includes a user interface application configured to run within a virtual machine in the dynamically loaded software platform.

In an embodiment further again, the application bundle is dynamically loaded onto the playback device.

A further additional embodiment includes a method of dynamically loading a software platform onto a playback device, the method including sending an identifier of the playback device to a configuration server, receiving a software platform configuration from the configuration server based upon the identifier, and dynamically loading a software platform identified using the software platform configuration from a content delivery network, where the software platform provides a runtime environment for applications onto the playback device.

In another additional embodiment, the identifier identifies the device.

In a still yet further embodiment, the identifier identifies a class of device.

In still yet another embodiment, the configuration server is configured by an administration console.

In a still further embodiment again, the dynamically loaded software platform includes at least one virtual machine, a common application container and a platform runtime.

In still another embodiment again, at least one application is packaged as an application bundle and is configured to run on top of the virtual machine and the common application container.

In a still further additional embodiment, the application bundle is dynamically loaded onto the playback device.

A still another additional embodiment includes a machine readable medium containing processor instructions, where execution of the instructions by a processor causes the processor to perform a process including sending an identifier to a configuration server, receiving a software platform configuration from the configuration server based upon the identifier, and dynamically loading a software platform defined by the software platform configuration that provides a runtime environment for applications onto the playback device from a remote server.

In a yet further embodiment again, sending an identifier including sending a request from a host application to a boot loader to initialize the boot loader, sending a request from the boot loader to a platform assembly module to initialize the platform assembly module, and sending the identifier from the platform assembly module to the configuration server.

In yet another embodiment again, the machine readable medium is non-volatile memory.

### BRIEF DESCRIPTION OF THE DRAWINGS

FIG. 1 is a system diagram of a content distribution system including playback devices configured by dynamically load software platforms in accordance with an embodiment of the invention.

FIG. 2 conceptually illustrates a playback device including a boot loader configured to dynamically load a software platform in accordance with an embodiment of the invention.

FIG. 3 illustrates components of a playback device in accordance with an embodiment of the invention.

FIG. 4 illustrates a software stack of a playback device in accordance with an embodiment of the invention.

FIG. 5 illustrates a dynamically loaded software platform in accordance with an embodiment of the invention.

FIG. 6 is a timing diagram illustrating a process for dynamically loading a software platform in accordance with an embodiment of the invention.

### DETAILED DESCRIPTION

Turning now to the drawings, systems and methods for dynamically loading a software platform for a playback device in accordance with embodiments of the invention are illustrated. The software platform dynamically loaded onto the playback device is a collection of components that provide a runtime environment for applications that can also be dynamically loaded onto the playback device. A software platform is software that configures a device to enable the execution of applications on the device. Where a device includes an operating system, a software platform typically sits on top of the device's operating system. In many instances a software platform includes a user interface enabling the loading of applications that execute within a runtime environment created by the software platform. The term runtime environment can be utilized to describe the software modules that can be called upon by an application that executes on top of the software platform. Software platforms are particularly useful for the development of applications that are platform independent. Software platforms can be utilized to provide a layer of abstraction between an application and the underlying device implementation and operating system. In this way, a single application can be written to run within a standard runtime environment created by a software platform and the application can rely upon the software platform to handle differences between devices and operating systems. In many embodiments, the software platform does not reside in the firmware of a device, but is instead dynamically loaded. The process of dynamic loading refers to fetching software from a remote server and loading the software into device memory in order to execute the software. When a playback device in accordance with embodiments of the invention dynamically loads a software platform, the playback device retrieves the software platform from a remote server and stores the software platform in memory. In several embodiments, the software platform includes at least one virtual machine, an application container and a platform runtime. In a number of embodiments, the playback device includes a platform installer that enables the playback device to discover and download a software platform configuration specific to the device or to a class of devices to which the device belongs from a configuration management server. In many embodiments, the software platform configuration is a set of dependent libraries, and the executables for a software platform configured for a particular device or class of devices. In this way, a software platform for a playback device can be assembled at runtime based on a set of constraints provided by the device (e.g. the formats it can playback, the bandwidth available to the device, and the device's memory capabilities) and the product intentions of OEMs. Software platforms defined by OEMs support specific applications and content. In addition, new functionality and/or updates to existing functionality can be delivered to consumer devices already deployed in the field in a manner that is “off cycle” with OEM software updates. The dynamic loading of software platforms for playback devices and the dynamic loading of components of a software platform to perform “off cycle” updates of the software platform and applications in accordance with embodiments of the invention are discussed further below.

### System Architecture

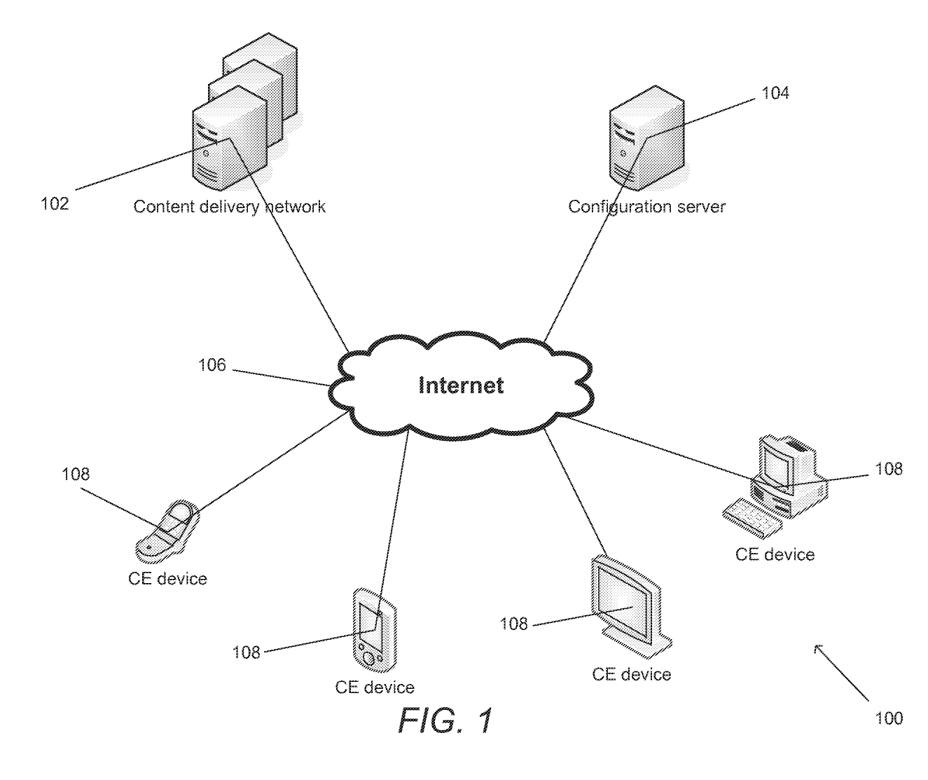

Playback devices in accordance with embodiments of the invention can dynamically load software platforms specific to the device or a class of the device. A content distribution system including playback devices configured to dynamically load software platforms in accordance with an embodiment of the invention is illustrated in FIG. 1. The content distribution system 100 includes various playback devices 108 that are connected with a configuration server 104 and a content delivery network 102 via the Internet 106. In many embodiments, different playback devices or classes of playback devices can dynamically load a software platform using a configuration generated by the configuration server 104 for each specific device or class or device. These dynamically loaded software platforms are downloaded from the content delivery network 102 allow for applications to run on top of the platform, including native and non-natively implemented applications that can utilize a common application container within the application platform that manages the applications running on top of the application platform.

Although specific embodiments are recited above, playback devices including a dynamically loaded software platform can be implemented in many different ways in many different embodiments of the invention, including where software platform configurations are uniform among playback devices or differ based upon parameters such as geographic region. Furthermore, although specific software platforms are described herein any of a variety of software platforms can be dynamically loaded in accordance with embodiments of the invention including (but not limited to) platforms that includes services containers such as the software platforms described in U.S. patent application Ser. No. 13/223,053 entitled “Systems and Methods for Common Application Platforms Utilizing Shared Services”, filed Aug. 31, 2011. The disclosure of U.S. patent application Ser. No. 13/223,053 is incorporated by reference herein in its entirety. Dynamic loading of software platforms on a playback device utilizing a platform assembly module in a platform installer are discussed below.

### Dynamic Loading of Software Platforms

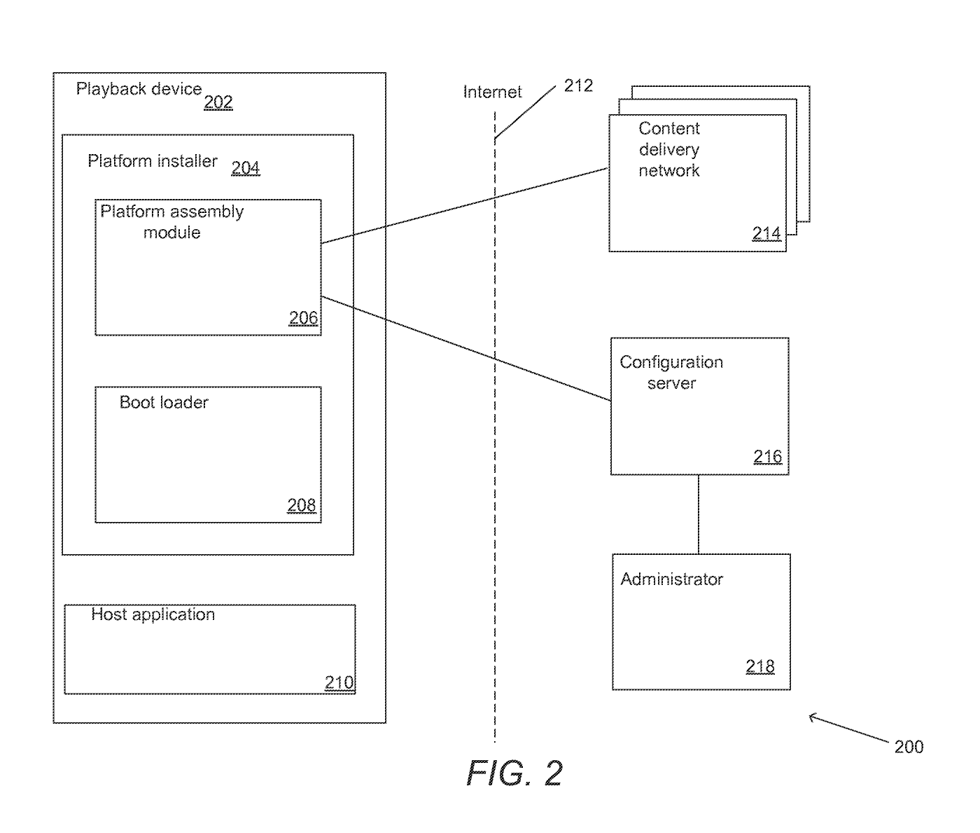

Playback devices can dynamically load a software platform in accordance with many embodiments of the invention using a dynamic software platform loading system including a host application that initializes a platform installer, which dynamically loads the software platform onto the playback device. A dynamic software platform loading system configured to enable playback devices to dynamically load software platforms in accordance with an embodiment of the invention is illustrated in FIG. 2. The dynamic loading system 200 includes a playback device 202 that is configured to communicate with a configuration server 216 via the Internet 206. The playback device 202 includes a platform installer component 204 implemented on top of the host application 210 of the playback device (i.e. the boot-up, resident application of the playback device). The platform installer component 204 is configured to download and unpack a software platform configuration from the configuration server 216. In many embodiments, the software platform configuration is a set of dependent libraries, and the executables for a software platform. In several embodiments, the software platform configuration is specifically defined for a class of devices. In a number of embodiments, the software platform configuration is specifically defined for the device. In this way, a software platform for a playback device can be assembled at runtime based on a set of constraints provided by the device and the product intentions of OEMs. Once the software platform configuration is downloaded, the configuration is used to download the components of the software platform. In the illustrated embodiment, the components of the software platform are downloaded from a content distribution network 214. In other embodiments, the components of the software platform can be downloaded from any source appropriate to the requirements of a specific application. A software platform configuration can include components of a software platform that are downloaded during the dynamic loading of the software platform, including but not limited to software libraries with reusable code, subroutines, classes, values or type specifications. In many embodiments, a software platform configuration can include at least one virtual machine, a common application container and a platform runtime. Once the components of the software platform are assembled in accordance with the software platform configuration, the software platform provides a runtime environment for applications.

In the illustrated embodiment, the installer component 204 includes a boot loader 208 and a platform assembly module 206. The boot loader 208 is configured to manage communication between the installer 204 and the playback device's host application 210. In many embodiments, the boot loader is concerned with handling life-cycle calls, and receiving event notifications from the host application. The boot loader 208 can also have responsibility for instantiating the platform assembly module 206.

In the illustrated embodiment, the platform assembly module 206 is configured to obtain a software platform configuration from the configuration server 216 that can be used to download the components of a specific software platform from a content delivery network 214 using the configuration. The platform assembly module 206 is also configured to unpack the software platform and save the software platform locally before initializing the software platform. In many embodiments, the locally stored software platform can be utilized for subsequent starts of the software platform. In several embodiments, the platform assembly module 206 then only downloads updates for components of the locally stored software platform. In other embodiments, the software platform is always downloaded prior to the initialization of the software platform.

In addition to identifying a specific software platform for the playback device to download, a software platform configuration can indicate the list of applications available on the software platform and their versions. The software platform configuration can also indicate the scope of content accessible by the playback device.

Software platform configurations are managed by the configuration server 216. An OEM can use an administration console 218 or similar mechanism to specify a variable number of devices as a set that runs on a specific software platform configuration. The configuration server 216 issues a unique ID with respect to each individual software platform specified by an OEM. Once the software platform configuration has been created, the OEM can use the administration console 218 to manage the software platform configuration. As noted above, the various settings that can be modified for a specific software platform include but are not limited to: the version of the software platform assigned to the specific software platform, the list of applications that are available on the specific software platform and the versions of the applications, and the content scope used by the specific software platform. In several embodiments, individual devices can be assigned device IDs and the OEM can manage the list of device IDs that belong to the specific software platform configuration. In addition, application developers can also be granted limited administration rights to modify the version number of applications that are approved for a specific software platform. In this way, both OEMs and application developers can push updates to playback devices in a secure fashion.

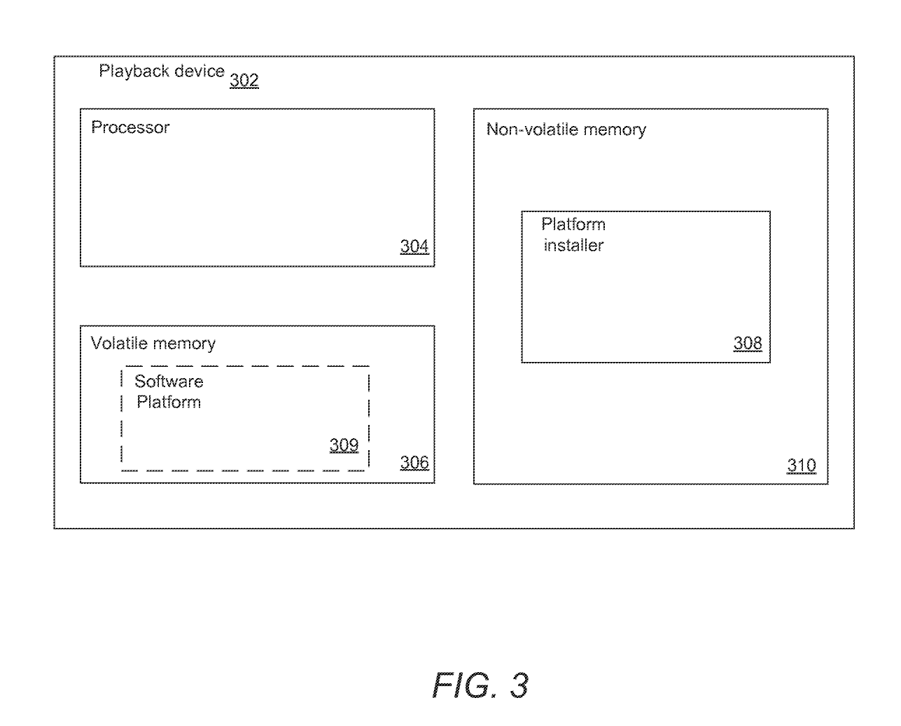

Playback devices that dynamically load software platforms in accordance with many embodiments of the invention can load a platform installer from non-volatile memory. Components of a playback device including non-volatile memory containing a platform installer in accordance with an embodiment of the invention are illustrated in FIG. 3. The playback device 302 includes a processor 304, volatile memory 306 and non-volatile memory 308 that includes a platform installer 308. In the illustrated embodiment, the non-volatile memory is a machine readable media that is utilized to store machine readable instructions that configure the processor. The non-volatile memory 310 contains the instructions (308) associated with a platform installer 308, which is utilized to configure the processor 304 to dynamically load a software platform 309. In many embodiments, a software platform 309 can be downloaded and stored into volatile memory 306. The software platform 309 further configures the processor so that application can run on top of the software platform. In many embodiments, platform installers can be loaded from any kind of memory including volatile memory in accordance with embodiments of the invention.

Although the dynamic loading of a software platform is described above with respect to specific playback device configurations, any of a variety of playback device configurations can be utilized to dynamically load a software platform onto the playback device from one or more remote servers as appropriate to specific applications in accordance with embodiments of the invention.

### Operation of CE Devices Using Dynamically Loaded Software Platforms and Applications

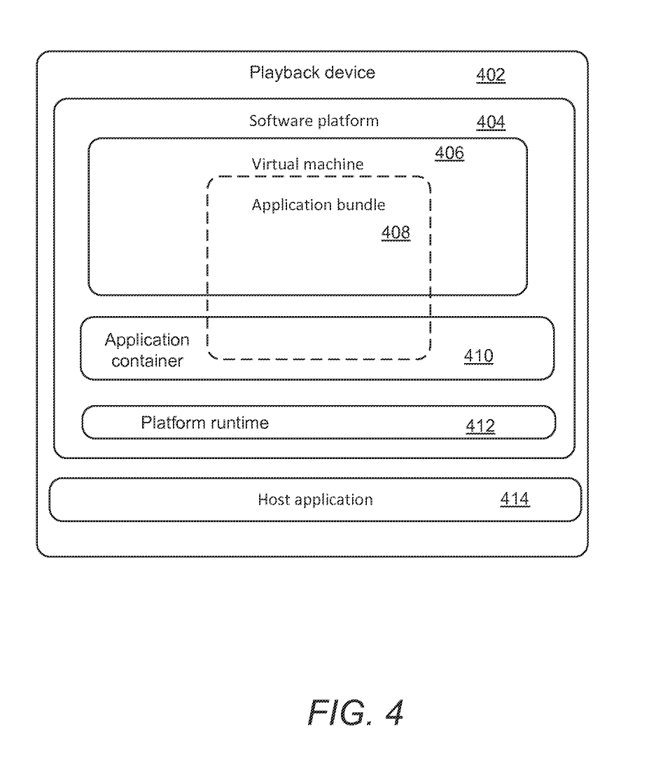

Software platforms dynamically loaded by playback devices in accordance with many embodiments of the invention include at least one virtual machine, an application platform and platform runtime, all of which run on top of a host application. A software stack on a playback device with a dynamically loaded software platform, which enables applications to execute on top of the software platform, in accordance with an embodiment of the invention is illustrated in FIG. 4. The software stack of the playback device 402 includes a software platform 404 that runs on top of a host application 414. The software platform 404 includes a virtual machine 406 and an application container 410, both of which run on top of a platform runtime 412 for the software platform 404. Applications, packaged as application bundles, can execute within the virtual machine 406 and the application container 410. Although a specific software stack is illustrated in FIG. 4, any of a variety of software stacks can be utilized where the software stack involves dynamically loading the software platform on top of a host application including (but not limited to) platforms that includes services containers such as the software platforms described in U.S. patent application Ser. No. 13/223,053 entitled “Systems and Methods for Common Application Platforms Utilizing Shared Services”, filed Aug. 31, 2011.

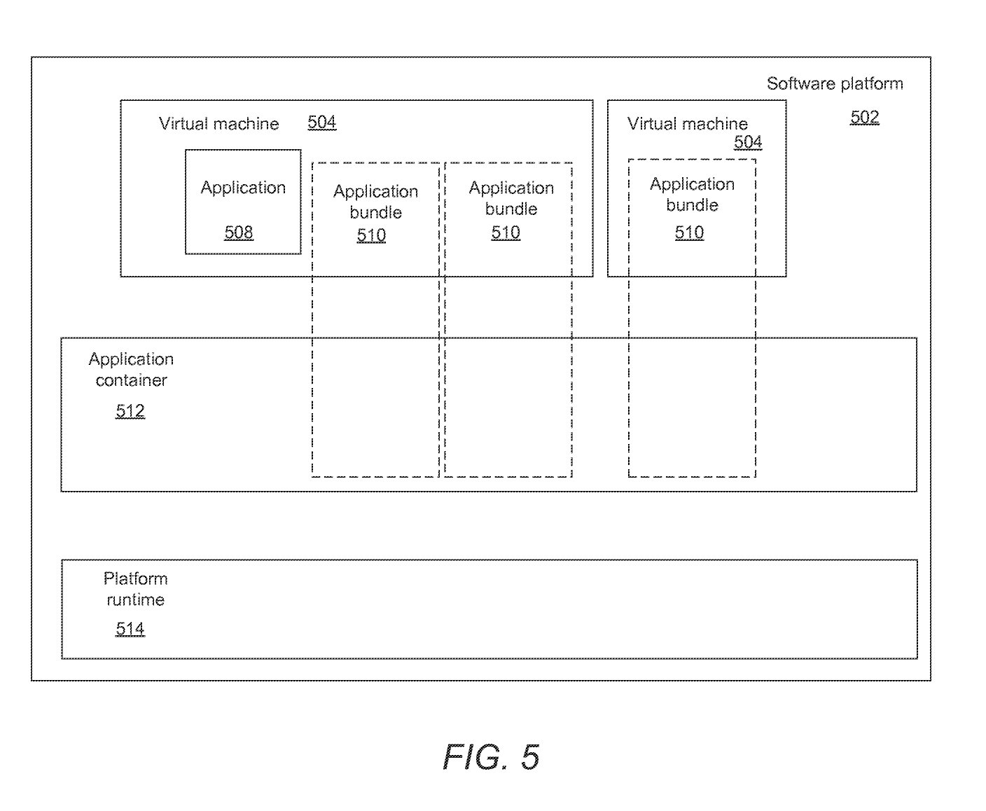

Dynamically loaded software platforms in accordance with many embodiments of the invention can include multiple virtual machines and a common application container on which applications can execute. A software platform where applications have been dynamically loaded in accordance with an embodiment of the invention is illustrated in FIG. 5. The dynamically loaded software platform 502 includes virtual machines 504, an application container 512 and the platform runtime process 514. Applications can be implemented within the runtime environment created on the playback device by the software platform by loading applications 508 capable of executing within the virtual machine. In a number of embodiments, the applications loaded into the virtual machine can utilize natively implemented code within the software platform. In several embodiments, the natively implemented code is provided in the form of a service within the application container 512 (or an equivalent container such as a services container). In many embodiments, the natively implemented code can be dynamically loaded with the application 508 as part of an application bundle 510. In the illustrated embodiment, there are multiple applications packaged as application bundles 510, which can be executed in different or common virtual machines 504. In several embodiments, the software platform also supports the dynamic loading of native code.

In many embodiments, the platform runtime process 514 is configured to interact with the playback device, and presents an abstraction layer for specific device functionality to applications running on the software platform. In several embodiments, the common device application container 32 provides a set of services and APIs for application packaged as application bundles 510 that allow developers to write native device modules that can be loaded and executed as part of the application bundles 510. The device application container 512 manages the life-cycle and configuration of the bundles 510.

In numerous embodiments, applications that execute on the software platform are packaged as bundles. Each bundle contains application binaries and a manifest file describing the content of the bundle and its configuration details. The manifest can be used by the software platform during system initialization to ensure that all of the required components are dynamically loaded (use of the manifest enables this process to be performed without executing the binaries associated with the application bundles). In a number of embodiments, the information contained within the manifest can include:

Application display name

Icon URL

Bundle type

Bundle version

Platform version dependency

Application executable location and initialization parameters

In several embodiments, the manifest can also be digitally signed to enable authentication of the manifest.

As can readily be appreciated, any component of the software platform and/or the application bundles can be dynamically loaded onto the playback device. In this way, “off cycle” updates can be performed independently of OEM update cycles. In addition, dynamic loading can be used as an alternative to storing the software platform locally on the CE device when not being utilized. Although a specific software platform supporting applications implemented using application bundles is illustrated in FIG. 5, any of a variety of software platforms can be dynamically loaded onto a playback device as appropriate to specific applications in accordance with embodiments of the invention.

### Processes for Dynamically Downloading Software Platforms to Playback Devices

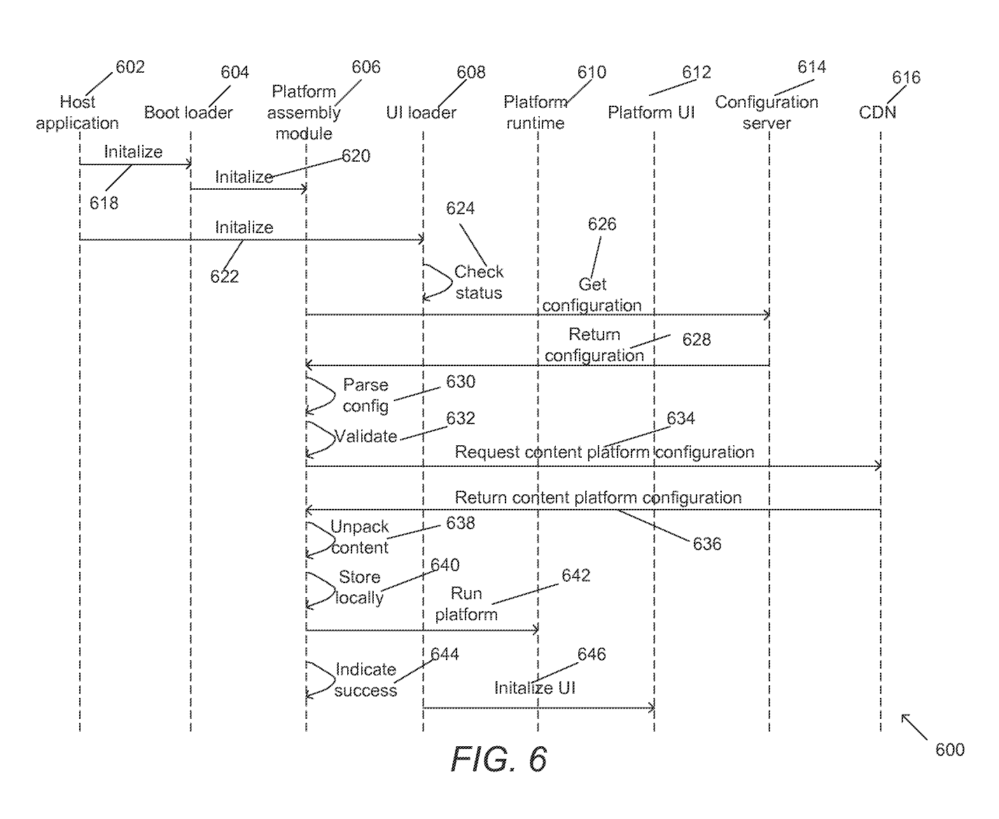

Host applications running on a playback device in accordance with embodiments of the invention can initialize a boot loader to dynamically load a software platform and initialize the user interface of an application platform, which can be used to dynamically load applications. Communication between a playback device, a configuration server, and a content delivery network during the dynamic loading of a software platform in accordance with embodiments of the invention is illustrated in FIG. 6. The process 600 of dynamically downloading the software platform commences when the host application 602 sends (618) a message initializing the boot loader 604. The boot loader 604 then initializes (620) the platform assembly module 606 and the host application 602 initializes (622) with the UI loader 608. The UI loader 608 is a component that reacts to the call from the host application 602 to initialize the UI of the platform. The UI loader waits (624) for the platform to be downloaded and initialized and then it initializes the platform UI 612. The platform assembly module 606 then provides (626) a device ID (in many embodiments the device MAC address) to the configuration server 614, which returns (628) a configuration file containing a software platform configuration. The platform assembly module parses (630) and validates (632) the file and then requests (634) and downloads (636) the appropriate software platform configuration from a content delivery network 616. In other embodiments, the software platform configuration can be downloaded from other sources including but not limited to a server that also functions as the configuration server. The platform assembly module 606 unpacks (638) the software platform configuration and locally stores (640) the software platform configuration. The platform assembly module then instantiates (642) the software platform runtime environment 610 using the software platform configuration. Once the software platform runtime environment 610 is indicated (644) as successfully launched, the software platform user interface 612 can be generated (646) and used to download applications and access content in accordance with the restrictions placed upon the software platform by the OEM. Although a specific process for dynamically loading a complete software platform is described above with respect to FIG. 6, a similar process can be utilized to simply update a portion of the software platform. In addition, alternative processes can be utilized to obtain all or part of a software platform as appropriate to a specific application in accordance with embodiments of the invention.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. Thus, embodiments of the present invention should be considered in all respects as illustrative and not restrictive.

What is claimed is:

1. A playback device, comprising:
a processor; and
memory containing a platform installer;
wherein the platform installer configures the processor to dynamically load a software platform from a remote server into device memory that provides a runtime environment for applications using a software platform configuration.

2. The playback device of claim 1, wherein the platform installer is configured to download the software platform configuration, where the software platform configuration specifies a set of software components that combine to form a software platform when downloaded to the playback device.

3. The playback device of claim 1, wherein the software platform configuration is specific to the playback device.

4. The playback device of claim 1, wherein the software platform configuration is specific to a class of playback device.

5. The playback device of claim 1 further comprising a host application that initializes the platform installer, wherein:
the platform installer further comprises a platform assembly module and a boot loader;
the boot loader is configured to manage communication between the installer and the host application; and
the platform installer utilizes the platform assembly module to download the software platform configuration and to dynamically download the software platform using the software platform configuration.

6. The playback device of claim 1, wherein the dynamically loaded software platform includes at least one virtual machine, a common application container and a platform runtime.

7. The playback device of claim 6, wherein the dynamically loaded software platform configures the processor to download at least one application.

8. The playback device of claim 7, wherein the at least one application is packaged as an application bundle and includes a user interface application configured to run within a virtual machine in the dynamically loaded software platform.

9. The playback device of claim 8, wherein the application bundle is dynamically loaded onto the playback device.

10. A method of dynamically loading a software platform onto a playback device, the method comprising:
sending an identifier of the playback device to a configuration server;
receiving a software platform configuration from the configuration server based upon the identifier; and
dynamically loading a software platform identified using the software platform configuration from a content delivery network, where the software platform provides a runtime environment for applications onto the playback device.

11. The method of claim 10, wherein the identifier identifies the device.

12. The method of claim 10, wherein the identifier identifies a class of device.

13. The method of claim 10, wherein the configuration server is configured by an administration console.

14. The method of claim 10, wherein the dynamically loaded software platform includes at least one virtual machine, a common application container and a platform runtime.

15. The method of claim 14, wherein at least one application is packaged as an application bundle and is configured to run on top of the virtual machine and the common application container.

16. The method of claim 15, wherein the application bundle is dynamically loaded onto the playback device.

17. A machine readable medium containing processor instructions, where execution of the instructions by a processor causes the processor to perform a process comprising:
sending an identifier to a configuration server;
receiving a software platform configuration from the configuration server based upon the identifier; and
dynamically loading a software platform defined by the software platform configuration that provides a runtime environment for applications onto the playback device from a remote server.

18. The machine readable medium of claim 17, wherein sending an identifier comprises:
sending a request from a host application to a boot loader to initialize the boot loader;
sending a request from the boot loader to a platform assembly module to initialize the platform assembly module; and
sending the identifier from the platform assembly module to the configuration server.

19. The machine readable medium of claim 17, wherein the machine readable medium is non-volatile memory.
